(19) United States
(12) Patent Application Publication
(10) Pub. No.: US 2025/0245982 A1
(43) Pub. Date: Jul. 31, 2025

(54) GENERATING BOUNDING BOXES FOR GEOLOCALIZING OBLIQUE AERIAL IMAGERY

(71) Applicant: X Development LLC, Mountain View, CA (US)

(72) Inventors: Charles Stephen Spirakis, Mountain View, CA (US); Alexander Thebelt, London (GB); Akshina Gupta, Warren, NJ (US); Naji Shajarisales, Pittsburgh, PA (US)

(21) Appl. No.: 19/034,380

(22) Filed: Jan. 22, 2025

Related U.S. Application Data
(60) Provisional application No. 63/627,014, filed on Jan. 30, 2024.

(51) Int. Cl. G06V 20/17; G06T 7/70

(52) U.S. Cl. CPC G06V 20/17; G06T 7/70; G06T 2207/10032; G06T 2207/30181; G06T 2207/30244

(57) ABSTRACT

Methods, systems, and apparatus for receiving a first image file recording a first image and a first set of metadata associated with the first image, determining that the first image depicts a horizon, and in response, providing a modified first set of metadata by applying a visibility radius to a projection of the Earth depicted in the first image, determining a tangent line based on the visibility radius, and adjusting a height of the first image based on the tangent line to provide a modified height in the modified first set of metadata, and outputting a first geographic features file that is generated using the modified first set of metadata, the first geographic features file including data representing one or more geographic features represented in the first image file.

### CROSS-REFERENCE TO RELATED APPLICATIONS

This application claims the benefit of U.S. Provisional Application No. 63/627,014 filed on Jan. 30, 2024, which is incorporated herein by reference.

### TECHNICAL FIELD

This specification generally relates to aerial imagery, and more particularly to generating bounding boxes for geolocalizing oblique aerial imagery.

### BACKGROUND

Aerial imagery can be described as capturing images of a surface, and features and/or content thereon, from a location above the surface. For example, aerial imagery of the Earth can include capturing images of the surface of the Earth and features thereon using a camera that is located above the surface. For example, an aircraft (e.g., plane, drone, helicopter, balloon) can carry a camera that captures images (aerial images) of the Earth from an altitude above the Earth. As another example, a passenger on an aircraft can carry a camera that captures images.

To make use of the aerial images, detailed information on the location of the camera, the pose of the camera, and the like can be needed. For example, to determine the features depicted in the image, a location of the camera and the pose of the camera relative to the surface of the Earth is needed. In many instances, the location of the camera can be provided using global positioning system (GPS) data that can provide a relatively precise location of the aircraft, and thus the camera, when the image is captured.

### SUMMARY

This specification describes systems, methods, devices, and other techniques relating to geolocalizing aerial imagery. More particularly, the technology of this application is directed to generating a geographic features file from an aerial image that potentially depicts a horizon.

In general, innovative aspects of the subject matter described in this specification can include actions of receiving a first image file recording a first image and a first set of metadata associated with the first image, determining that the first image depicts a horizon, and in response, providing a modified first set of metadata by applying a visibility radius to a projection of the Earth depicted in the first image, determining a tangent line based on the visibility radius, and adjusting a height of the first image based on the tangent line to provide a modified height in the modified first set of metadata, and outputting a first geographic features file that is generated using the modified first set of metadata, the first geographic features file including data representing one or more geographic features represented in the first image file. Other implementations of this aspect include corresponding systems, apparatus, and computer programs, configured to perform the actions of the methods, encoded on computer storage devices.

These and other implementations can each optionally include one or more of the following features: actions further include determining an unrolled camera for the first image, the tangent line being determined based on the unrolled camera; the unrolled camera is provided by adjusting the first image such that the horizon is parallel to at least one edge of the first image; the visibility radius is less than a distance of the horizon from a center of a camera projected to the Earth; actions further include determining bounding box data using the first set of modified metadata, wherein the one or more geographic features represented within the first geographic features file are at least partially located within a bounding box defined by the bounding box data; actions further include receiving a second image file recording a second image and a second set of metadata associated with the second image, and determining that the second image does not depict a horizon, and in response, outputting a second geographic features file that is generated using the second set of metadata, the second geographic features file comprising data representing one or more geographic features represented in the second image file; and determining that the first image depicts a first horizon comprises processing the first image through a machine learning (ML) model that classifies the first image as depicting a horizon.

The present disclosure also provides a non-transitory computer-readable storage medium coupled to one or more processors and having instructions stored thereon which, when executed by the one or more processors, cause the one or more processors to perform operations in accordance with implementations provided herein.

It is appreciated that the methods and systems in accordance with the present disclosure can include any combination of the aspects and features described herein. That is, methods and systems in accordance with the present disclosure are not limited to the combinations of aspects and features specifically described herein, but also include any combination of the aspects and features provided.

Particular implementations of the subject matter described in this specification can be executed so as to realize one or more of the following advantages. For example, implementations of the present disclosure enable use of images that would otherwise be unusable (because they depict a horizon) in geolocalizing. In this manner, the resources expended in generating and processing the images are not wasted and capturing new images (expending further resources) can be avoided. Further, equipment, flight posture, camera posture, and the like to ensure that only images that do not depict a horizon are captured can be avoided. That is, because implementations of the present disclosure enable use of images depicting horizons in geolocalizing, measures to avoid capturing images without horizons are unnecessary.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a conceptual representation of capturing images at oblique angles.

FIG. 2 depicts an image geolocalizing pipeline in accordance with implementations of the present disclosure.

FIG. 3 depicts an example bounding box module in accordance with implementations of the present disclosure.

FIGS. 4A and 4B depict respective representations for calculating a bounding box in aerial images that depict a horizon.

FIG. 5 is a flow diagram of an example process in accordance with implementations of the present disclosure.

Like reference numbers and designations in the various drawings indicate like elements.

### DETAILED DESCRIPTION

The technology of this patent application is directed to geolocalizing aerial imagery. More particularly, the technology of this application is directed to generating a geographic features file from an aerial image that potentially depicts a horizon.

To provide context for implementations of the present disclosure, and as introduced above, aerial imagery of the Earth can include capturing images of the surface of the Earth and features thereon using a camera that is located above the surface of the Earth. For example, an aircraft (e.g., plane, drone, helicopter, balloon) can carry a camera that captures images (aerial images) of the Earth from an altitude above the Earth. In some instances, images can be captured directly above the Earth. In some instances, images can be captured at oblique angles relative to the Earth.

To make use of aerial images, the images can be geolocalized. In some examples, geolocalizing refers to determining features depicted in the images. Features can include natural features and manmade features (collectively, geographic features). To geolocalize aerial images that are taken from oblique angles relative to the Earth, detailed information on the location of the camera, the pose of the camera, and the like can be needed. For example, to determine the geographic features depicted in the image, a location of the camera and the pose of the camera relative to the surface of the Earth is needed.

In some examples, a geographic features file can be generated from an image based on location information and pose information, the geographic features file recording geographic data that represents geographic features depicted in the image. The geographic features file can be provided in a format, such as GeoJSON. GeoJSON can be described as a geospatial data interchange format that is based on JavaScript Object Notation (JSON). GeoJSON defines several types of JSON objects and how they are combined to provide geographic data that represents geographic features (e.g., natural features, manmade features) as well as the properties and spatial extents of the geographic features. Further detail on GeoJSON is provided in RFC 7946, published by the Internet Engineering Task Force (IETF) in August 2016.

In many instances, the location of the camera can be provided using global positioning system (GPS) data that can provide a relatively precise location of the camera when the image is captured. In some instances, the pose of the camera and other information that that may be related to when the image was captured is available for generation of the geographic features file. In some instances, the pose of the camera, or at least portions thereof, and/or other information that may be related to when the image was captured might not be available. In such instances, pose data can be determined using one or more techniques. Example techniques are disclosed in commonly assigned U.S. Prov. App. No. 63/627,004, the disclosure of which is expressly incorporated herein by reference in the entirety for all purposes.

In order to geolocalize an image, a bounding box is determined for the image. While the term bounding box is used herein, it is contemplated that the bounding box can be any appropriate shape that can be defined by multiple vertices, each vertex representing a point on the surface of the Earth and being defined by a latitude and a longitude (e.g., a rectangle, a square, a trapezoid). The bounding box encompasses a geographic area depicted in the image.

Multiple techniques can be used to generate a bounding box for images that do not depict a horizon. For example, in the case that an image does not depict a horizon, an assumption can be made that the Earth is relatively flat in the geographic area depicted in the image, such that the curvature of the Earth need not be accounted for. Using this assumption, geometry can be used to calculate distances and bearings from a camera location projected onto the ground to vertices of a bounding box. The distances and bearings can be converted to latitude and longitude of the vertices. An example library for converting points in images to vertices of a bounding box includes Camera Transform, which is described in CameraTransform: A Python package for perspective corrections and image mapping, Gerum et al. (2019).

However, it can occur, and often does occur, that images depict a horizon. In such instances, traditional techniques for determining bounding boxes are not effective in generating useful bounding boxes. For example, such techniques result in the bounding box being determined in a direction that is opposite to what is depicted in the image and/or being too large to be useful. Such occurrences can be referred to as a large tilt scenario and/or the horizon problem.

In view of the foregoing, implementations of the present disclosure provide an image geolocalizing pipeline to generate a geographic features file (e.g., GeoJSON file) from images that depict horizons. In some implementations, and as described in further detail herein, a frame of an image that depicts a horizon is modified, such that a top edge of the frame is reduced to cut out the horizon and to represent a meaningful distance within the image. A meaningful distance can include a distance that captures geographic features of interest and limiting geographic features that are not of interest (e.g., features that are too far off in the distance). In some implementations, the image geolocalizing pipeline of the present disclosure further includes identifying features depicted in the bounding box and recording the features in a geographic features file (e.g., GeoJSON file).

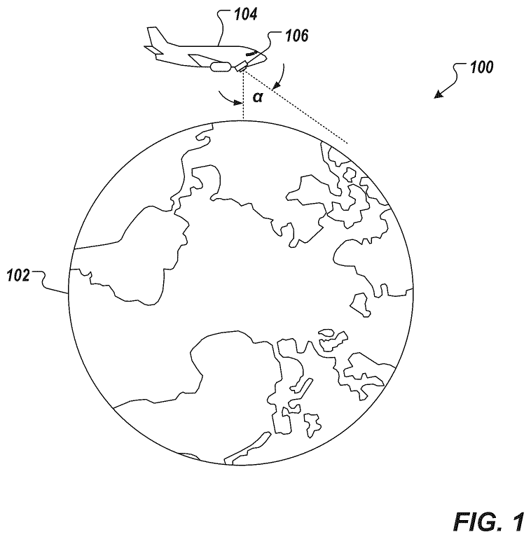

FIG. 1 is a conceptual representation 100 of capturing images at oblique angles. The conceptual representation 100 includes the Earth 102, an aircraft 104 flying above the Earth 102, and a camera 106 associated with the aircraft 104 to capture images of the Earth. For example, the camera 106 can be mounted (e.g., fixedly, movably) to the aircraft 104. As another example, the camera 106 can be a handheld camera (e.g., a passenger within the aircraft 104 holding the camera). In some examples, the camera 106 can be any appropriate type of camera that can capture images that are stored in a computer-readable digital image file.

As represented in FIG. 1, the vertical field-of-view (FOV) of the camera 106 is at an angle α relative to a surface of the Earth, where α≠0. That is, instead of the FOV pointing straight-down toward the surface of the Earth, the camera 106 is at the angle α. As such, images captured by the camera 106 are at an oblique angle (the angle α) relative to the surface of the Earth. In the depicted example, the camera 106 is at such an angle that a horizon is captured in images generated by the camera 106.

In some implementations, an image captured by the camera 106 (also referred to as an actual image) includes metadata associated therewith, the metadata representing location data and/or pose data. Example metadata is provided in Table 1:

TABLE 1
Example Image Metadata

| Metadata | Variable | Description |
|---|---|---|
| Latitude | lat | float, [−90, 90] |
| | | (degrees) |
| Longitude | lon | float, [−180, 180] |
| | | (degrees) |
| Altitude | alt | float (meters) |
| Focal Length | focal_length_35 mm | float |
| (35 mm equivalent) | | |
| Pixel Width of Image | width | float |
| Pixel Height of Image | height | float |
| Tilt of Camera Pose | tilt | float, [0, 90] |
| (Pitch) | | (degrees) |
| Heading of Camera Pose | heading | float, [−180, 180] |
| (Yaw) | | (degrees from North) |
| Roll of Camera Pose | roll | float |
| FOV in y-Direction | fov_y | float, [0, 180] |

In some examples, metadata can be recorded by the camera 106 when capturing an image. For example, and without limitation, the camera 106 can record focal length, pixel width, and pixel height. As another example, the camera 106 can record FOV (e.g., based on focal length and size of sensor used to capture images). As another example, the camera 106 can record latitude and longitude (e.g., in instances where the camera 106 is associated with a GPS module, such as a smartphone having the camera 106 therein). As another example, the camera 106 can record altitude (e.g., in instances where the camera 106 is associated with a barometric altimeter).

In some examples, metadata can be recorded external to the camera 106 when capturing an image and can be added to the image file. For example, and without limitation, the aircraft 104 (e.g., sensors thereon) can record latitude, longitude, and/or altitude when an image is captured and the values can be populated as metadata in the image file that records the image.

In some examples, at least a portion of the metadata, including pose data, is not recorded for an image when the image is captured. For example, and without limitation, an image can be captured and can be absent longitude, latitude, altitude, tilt, heading, and/or roll. For example, it can occur that sensors necessary for recording one or more of longitude, latitude, altitude, tilt, heading, and/or roll for the camera 106, among other metadata, are absent.

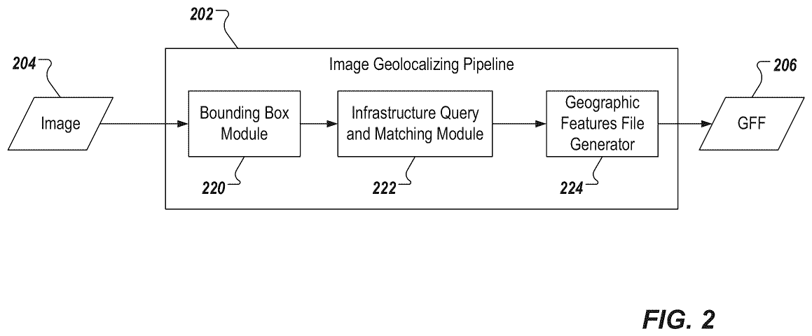

FIG. 2 depicts an image geolocalizing pipeline 202 in accordance with implementations of the present disclosure. In some examples, the image geolocalizing pipeline 202 can be provided as a cloud-based service (e.g., a Google Cloud Platform (GPC) service) that receives an image 204 (e.g., a computer-readable image file) and processes the image 204 to provide a geographic features file (GFF) 206 (e.g., a GeoJSON file). For example, and without limitation, the image geolocalizing pipeline 202 can periodically check (e.g., x times per day) an image store for the presence of new images (e.g., images that have been added to the image store and have not yet been processed). When a new image is detected, the image can be copied to a dedicated storage bucket for processing. In some examples, an alert is sent to the image geolocalizing pipeline 202 when an image is added to the image store and in response to the alert, the image can be copied to the dedicated storage bucket for processing.

In the example of FIG. 2, the image geolocalizing pipeline 202 includes a bounding box module 220, an infrastructure query and matching module 222, and a geographic features file generator 224. As described in further detail herein, the bounding box module 220 receives the image 204, geolocates the image 204, and generates a bounding box for the image 204. In some examples, the bounding box maps a frame of reference of the image to coordinates.

The infrastructure query and matching module 222 processes the bounding box to identify, for example and without limitation, geographic features, such as manmade features, populating the bounding box. Example manmade features can include infrastructure and/or resources, such as roads, buildings, bridges, and the like. Example infrastructure can be described as Critical Infrastructure and Key Resources (CIKR) that is represented in multiple categories as published by the Cybersecurity and Infrastructure Security (CISR) Agency of the United States. For example, the bounding box can be used to query an asset dataset to identify assets located within the bounding box. In some examples, features with known locations (latitude and longitude) and listed in the Homeland Infrastructure Foundation-Level Data (HIFLD) dataset (asset dataset), provided by the U.S. Department of Homeland Security, are identified within the bounding box. In some examples, assets located in the bounding box can be represented in a query to a CIKR database that returns a query result representing CIKR categories, if any, for assets located within the bounding box. That is, for example, assets in the bounding box can be categorized into CIKR categories.

In some implementations, the geographic features file generator 224 generates the GFF 206 based on the image 204, the assets, and the CIKR categories, if any. For example, the GFF 206 can include GeoJSON tags as represented in the below example:

Listing 1: Example GeoJSON Tags for GFF

```
{
  “type”:“FeatureCollection”,
  “features”:
    [
    {“type”: “Feature”, “geometry”:{ “type”: “Point”,
“coordinates”: [ −86.5593171, 35.9231227] }, “properties”:
{“name”: “Stewarts Creek High School”, “sector”:
“Government Facilities”, “associated_images”:
[“DSC_1011.JPG”] } },
    {“type”: “Feature”, “geometry”:{ “type”: “LineString”,
“coordinates”: [ [ −87.608051, 35.975516 ], [ −87.607752,
35.974770] ] }, “properties”: {“name”: “Indian Creek Road”,
“sector”: “Transportation”, “associated_images”:
[“DSC_0577.JPG” ] } }
    ]
}
```

As introduced above, and in some instances, the pose of the camera and other information that may be related to when the image was captured is available for generation of the geographic features file. In such instances, the bounding box can be determined for the image. In some instances, the pose of the camera, or at least portions thereof, and/or other information that may be related to when the image was captured might not be available. In such instances, missing pose data can be determined using one or more techniques, such as those described in commonly assigned U.S. Prov. App. No. 63/627,004 introduced above.

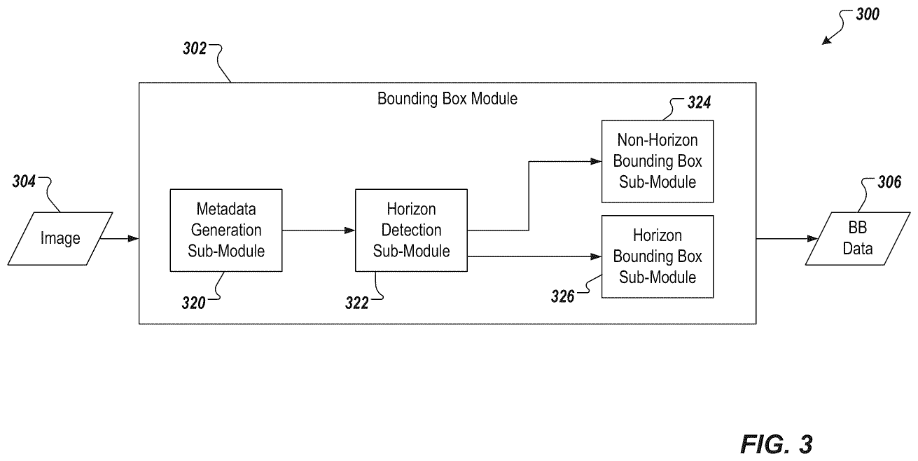

FIG. 3 depicts an example bounding box module 302 in accordance with implementations of the present disclosure. The bounding box module 302 can be provided as the bounding box module 220 of FIG. 2. In the example of FIG. 3, the bounding box module 302 includes a metadata generation sub-module 320, a horizon detection sub-module 322, a non-horizon bounding box sub-module 324, and a horizon bounding box sub-module 326.

In accordance with implementations of the present disclosure, the bounding box module 302 receives an image 304 (e.g., the image 204 of FIG. 2) and provides bounding box (BB) data 306. In some examples, the BB data 306 includes geographic coordinates of a bounding box of a geographic area represented in the image 304. In some examples, the bounding box is provided as a geometric shape (e.g., triangle, square, rectangle, trapezoid) having multiple vertices, each vertex being associated with geographic coordinates (latitude, longitude).

In some implementations, the bounding box module 302 determines whether the image 304 is absent metadata that can be required to determine the bounding box. For example, the bounding box module 302 can determine whether at least a subset of metadata for the image 304 is complete (e.g., each metadata in the subset of metadata is populated with a value). The subset of metadata can include metadata (e.g., pose data) that is required to geolocalize the image. In some examples, if the subset of metadata is complete, the image 304 is provided to the horizon detection sub-module 322. If the subset of metadata for the image 304 is not complete or the bounding box module 302 determines that the image 304 does not include at least a subset of metadata, the metadata generation module 320 processes the image 304 to determine metadata for the image 304 and the image 304 (with determined metadata) is provided to the horizon detection sub-module 322. In some examples, absent metadata can be determined using techniques disclosed in commonly assigned U.S. Prov. App. No. 63/627,004 introduced above.

In some implementations, the horizon detection sub-module 322 determines whether the image 304 depicts a horizon. In some examples, the image 304 can be processed to determine whether all rays of camera corners emitting from the camera focal point (discussed in further detail below) intersect with the Earth, as depicted in the image 304. If at least one ray does not intersect with the Earth, it is determined that the image 304 depicts a horizon. In some examples, the image 304 can be processed through a machine learning (ML) model that is trained to detect presence (or absence) of a horizon in images. In some examples, the ML model is a classifier that classifies each image into one of multiple classes, example classes including horizon and no horizon.

If the image 304 is classified in the no horizon class, the image 304 is provided to the non-horizon bounding box sub-module 324. In some examples, the non-horizon bounding box sub-module 324 processes the set of metadata using a traditional technique to determine the BB data 306 for the image 304. Listing 2 provides example code for generating BB data:

Listing 2: Example Code for Bounding Box Generation

```
    class DetermineBoundingBox( ):
def _{——}init_{——}(self,
          lat: float,
          lon: float,
          alt: float,
          heading: float,
        tilt: float,
          roll: float,
          fov_y: float,
          height: float,
        width: float):
  ″″″
Args:
      lat (float): latitude
      lon (float): longitude
      alt (float): altitude
      heading (float): heading of the image
      tilt (float): tilt of the image
      roll (float): roll of the image
      fov_y (float): field of view in y direction
      height (float): height of the image
      width (float): width of the image
  ″″″
def generate_bbox( ):
  ″″″
  generate bounding box based on the metadata of the photo
  Returns:
  List[[lon, lat], ...]
  ″″″
  return [[1.0, 1.0], [1.0, 2.0], [2.0, 1.0], [2.0, 2.0]]
```

If the image 304 is classified in the horizon class, the image 304 is provided to the horizon bounding box sub-module 326. In some examples, the horizon bounding box sub-module 326 processes the set of metadata in accordance with implementations of the present disclosure to determine the BB data 306 for the image 304. More particularly, a frame of an image that depicts a horizon is modified, such that a top edge of the frame is reduced to cut out the horizon and to represent a meaningful distance within the image. Here, a meaningful distance can include a distance that captures geographic features of interest and limiting geographic features that are not of interest (e.g., features that are too far off in the distance). The BB data 306 is determined for the image 304 using a modified set of x-y coordinates determined for the adjusted frame of the image 304. For example, and without limitation, a modified height for the image 304 can be provided and replaces the height used in Listing 2, above.

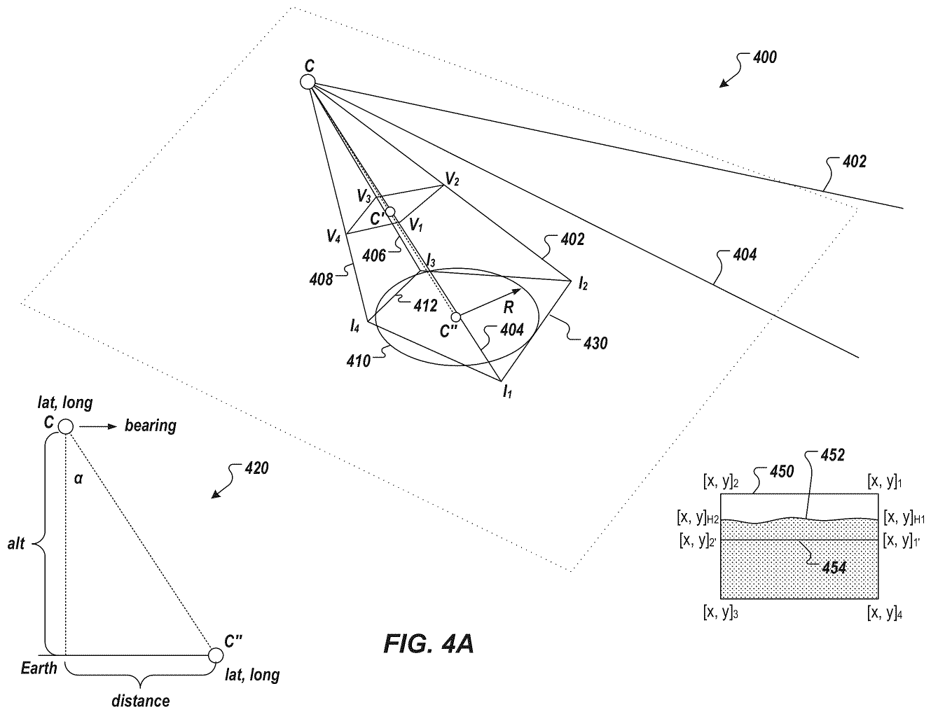

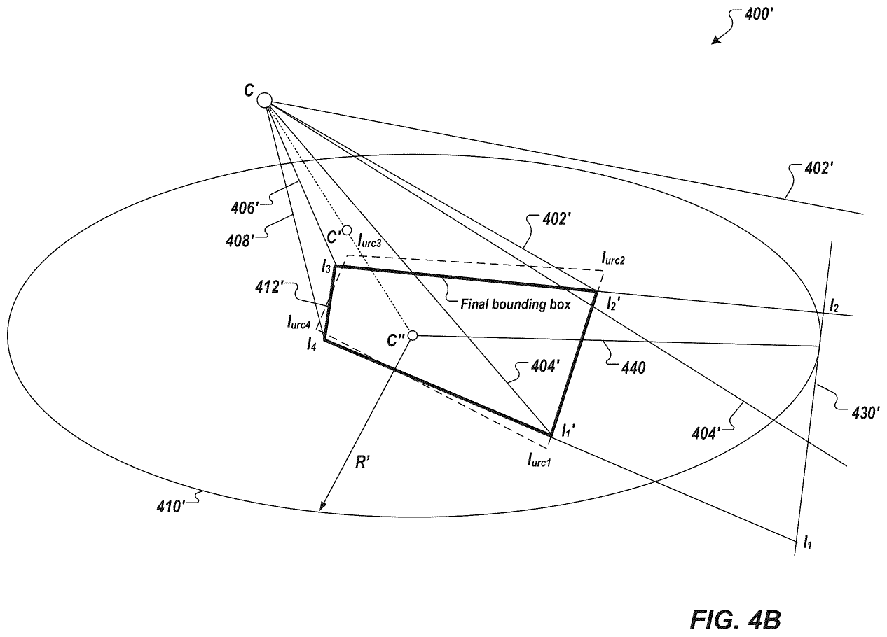

FIG. 4A is a representation 400 for calculating bounding boxes in aerial images that depict a horizon in accordance with implementations of the present disclosure. In the example of FIG. 4A, a camera that captured the image has a center at C and rays of the camera are provided as a ray 402, a ray 404, a ray 406, and a ray 408. The rays 402, 404 project out over the horizon and the rays 406, 408 intersect with the Earth at I₃, I₄, respectively. A line 412 is provided between I₃ and I₄. In this example, the center of the camera viewfinder is pointed at Earth and can be projected to a point C″ on the Earth. For example, a projection representation 420 depicts projection of C to the point C″ using trigonometry. In the example of FIG. 4A, C′ is of a distance equal to 1 from C in the camera frame of reference. As such, V₁, V₂, V₃, V₄, can be defined by intersecting the plane perpendicular to C′ and intersecting the plane with the rays 402, 404, 406, 408.

In some examples, a visibility radius R is provided to define a circle 410. In some examples, geographic features that are outside of the circle 410 are presumed to be not of interest in the image. More particularly, the point C″ is the center that the camera is pointed at and is, hence, a point of interest. In some examples, the visibility radius R around the point C″ can be a predetermined distance (e.g., half a mile or an equivalent in GPS coordinates). A tangent line 430 is drawn tangent to this circle 410 parallel to the line 412 extending between I₃ and I₄. The rays 402, 404 are drawn downward (e.g., the angle of the rays 402, 404 relative to C is decreased) until each intersects the tangent line 430 at I₁ and I₂, respectively. In a case where roll is zero, this will coincide with reducing the field of view in the y-direction until the rays 402, 404 intersect with the Earth at I₁ and I₂, respectively.

FIG. 4A depicts an image 450 including a horizon 452. The frame of the image is defined by a set of x, y coordinates, namely, [x, y]₁, [x, y]₂, [x, y]₃, [x, y]₄. In this example, edges of the horizon are at x, y coordinates [x, y]_{H1}, [x, y]_{H2}. In accordance with implementations of the present disclosure, a top edge of the frame is reduced to remove the horizon and be sufficiently below the horizon to capture geographic features of interest. For example, just reducing the top edge to remove the horizon will still capture geographic features that are too far in the distance to be of interest. In some examples, the visibility radius R is used to limit how far off in the distance the top edge is, as described herein.

In the example of FIG. 4A, a top edge 454 is reduced to cut off the horizon 452 and to limit the size of the resulting bounding box. Consequently, the frame of the image 450 is defined by a modified set of x, y coordinates, namely, [x, y]_{′}, [x, y]_{2′}, [x, y]₃, [x, y]₄, which respectively correspond to intersections I₁, I₂, I₃, I₄ of FIG. 4A. Here, the height of the image has been modified from its original height. That is, a modified height has been determined for the image 450 and can be used to determine the bounding box (e.g., replacing the height of Listing 2 with the modified height).

In some examples, the intersections between the rays 402, 404 and the tangent line 430 can be determined using a tangent method that can be implemented using a mathematics library. An example mathematics library includes the SymPy Library provided by the SymPy Development Team. FIG. 4B is a representation 400′ for calculating bounding boxes in aerial images that depict a horizon in accordance with implementations of the present disclosure. In the example of FIG. 4B, a camera that captured the image has a center at C and rays of the camera are provided as a ray 402′, a ray 404′, a ray 406′, and a ray 408′. The rays 402′, 404′ project out over the horizon and the rays 406′, 408′ intersect with the Earth at I₃, I₄, respectively. A line 412′ is provided between I₃ and I₄. In this example, the center of the camera viewfinder is pointed at Earth and can be projected to a point C″ on the Earth. For example, the projection representation 420 of FIG. 4A depicts projection of C to the point C″ using trigonometry.

In some examples, a visibility radius R′ is provided to define a circle 410′. In some examples, geographic features that are outside of the circle 410′ are presumed to be not of interest in the image. More particularly, the point C″ is the center that the camera is pointed at and is, hence, a point of interest. In some examples, the radius R′ around the point C″ can be a predetermined distance (e.g., a relatively large value). A tangent line 430′ is drawn tangent to this circle 410′ parallel to the line 412 extending between I₃ and I₄. A line 440 between C″ and the tangent point is perpendicular to the line 430′.

In some implementations, unrolled camera (urc) is created that has all of the pose information of the original camera that captured the image except with roll equal 0. Here, the unrolled camera can refer to adjusting the image, such that the horizon is actually horizontal (e.g., parallel to top/bottom edges of the image, perpendicular to left/right edges of the image). The bounding box of the unrolled camera has corners I_{urc1}, . . . I_{urc4}.

It can be noted that, for both the camera and the unrolled camera, the C, C′, and C″ are the same. A benefit of the unrolled camera is that it can help perfectly trim the horizon out of the bounding box, because the upper plane of the unrolled camera pyramid is parallel to the horizon line, but the bounding box of drastically differ from the original camera as I₃ and I₄ will significantly change. The upper plane of the unrolled camera is used to tangentially intersect with the circle 410′. The left plane of the camera pyramid is intersected with this line to determine I₂ and the right plane is intersected with this line to determine I₁. Here, the mathematical library can be used to execute the intersections and determine I₁ and I₂. For example, SymPy can be used, which provides a symbolic way of doing cartesian geometry. This means that given a symbolic representation of a line, such as (x, y, z)=(x₀, y₀, z₀)+t v, where v is a vector, the intersection with an arbitrary circle, such as x²+y²=R, can be determined. In the context of the present disclosure, given I_{urc3}, I_{urc4}, and the visibility circle, there is only one line that can be drawn—mathematically speaking—that is tangent to the visibility circle and that is parallel to the line passing through I_{urc3} and I_{urc4}. This is the tangent line 430′. SymPy can be used to determine the tangent line 430′. The tangent line 430′ can be intersected with planes passing through V₁, V₄, and C, as well as the plane passing through V₂, V₃, and C. The intersection points of these planes provide I₁′ and I₂′, which can be the extremities of points visible in the original image at the two ends of the tangent line 430′. After getting the bounding box of the unrolled camera (which happens together with applying the visibility radius, as discussed above), I₁′, I₂′, I₃, and I₄ define the final bounding box. In some examples, I_{urc1}, I_{urc2}, I₃, and I₄ can define the final bounding box.

Referring again to FIG. 3, the output of either the non-horizon bounding box sub-module 324 or the horizon bounding box sub-module 326 is the bounding box data 306. In some examples, the bounding box data includes a set of vertices, each vertex being defined as a latitude and longitude pair (e.g., [lat, lon]). The image 304 and the BB data 306 can be used to identify features located within the bounding box. For example, and as described herein, the infrastructure query and matching module 222 of FIG. 2 can process the BB data 306 to identify, for example and without limitation, geographic features, such as manmade features, populating the bounding box. Example manmade features can include infrastructure and/or resources, such as roads, buildings, bridges, and the like, which can be categorized into categories (e.g., CIKR categories). The geographic features file generator 224 of FIG. 2 generates the GFF 206 based on the image 204 (e.g., the image 304), the assets, and the CIKR categories, if any.

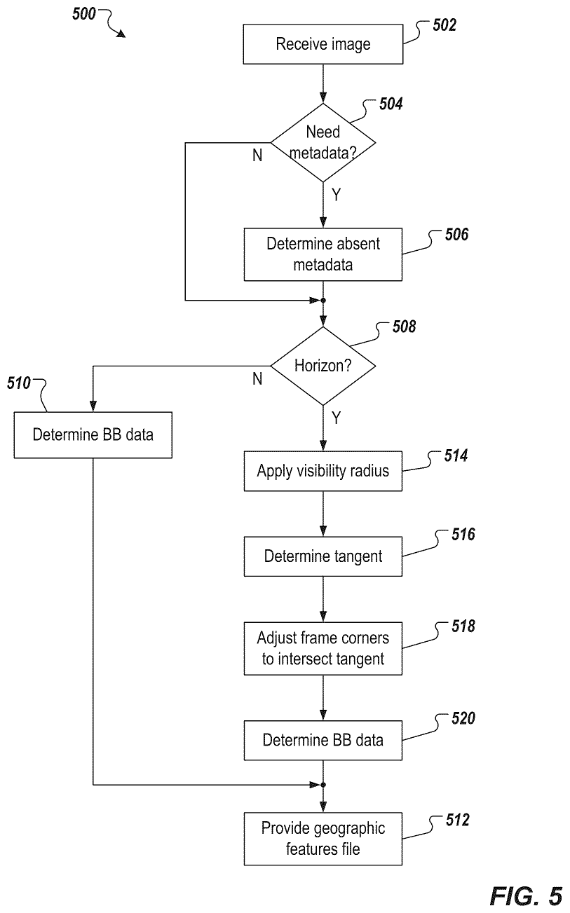

FIG. 5 is a flow diagram of an example process 500 in accordance with implementations of the present disclosure. In some examples, the example process 500 is provided using one or more computer-executable programs executed by one or more computing devices.

An image is received (502). For example, and as described herein with reference to FIG. 3, the bounding box module 302 receives the image 304. It is determined whether metadata is needed (504). For example, and as described herein, the bounding box module 302 determines whether the image 304 is absent metadata that can be required to determine the bounding box. For example, the bounding box module 302 can determine whether at least a subset of metadata for the image 304 is complete, where the subset of metadata includes metadata (e.g., pose data) that is required to geolocalize the image. For example, if the metadata for the image 304 includes values for each of [lon, lat, alt, heading, tilt, roll, fov_y], it is determined that metadata is not needed. As another example, if the metadata for the image 304 includes values for each of [lon, lat, alt], but is absent metadata for one or more of [heading, tilt, roll, fov_y], it can be determined that metadata is needed.

If metadata is needed, absent metadata is determined. For example, and as described herein, the absent metadata can be determined as discussed in U.S. Pat. App. No. 63/627,004 introduced above. It is determined whether a horizon is depicted in the image (508). For example, the image 304 can be processed through a ML model of the horizon detection sub-module 322, which classifies the image 304 as either depicting a horizon or not depicting a horizon. If no horizon is depicted in the image, BB data is determined for the image (510) and a geographic features file is provided (512). For example, and as described herein, the set of metadata is processed by the non-horizon bounding box sub-module 324 to provide the BB data 306. In some examples, a library (e.g., CamerTransform) is executed by the non-horizon bounding box sub-module 324 to determine the BB data 306. The BB data 306 is processed by the infrastructure query and matching module 222 of FIG. 2 to identify assets (e.g., manmade features) within the bounding box and categorize assets (e.g., using CIKR categories). This information is provided to the geographic features file generator 224, which provides the GFF 206.

If a horizon is depicted in the image, the top edge of the image is adjusted to remove the horizon and to represent a meaningful distance within the image to avoid irrelevant geographic features. More particularly, a visibility radius is applied (514), a tangent line is determined (516), frame corners are adjusted to intersect the tangent line (518), and BB data is determined (520). For example, and with non-limiting reference to FIG. 4A, the visibility radius R is applied to provide the circle 410, the tangent line 430 is determined tangent to the circle 430, and the frame corners of the top edge are adjusted downward until intersecting the tangent line. In this manner, a modified set of x-y coordinates is provided for the image, which can include [x, y]_{1′}, [x, y]_{2′}, [x, y]₃, [x, y]₄, as depicted in FIG. 4A. In some examples, the BB data is determined using the modified set of coordinates (e.g., by processing though the transform library), and a geographic features file is provided (512). For example, and as described herein, the modified set of metadata is processed by the horizon bounding box sub-module 324 to provide the BB data 306, which is processed by the infrastructure query and matching module 222 of FIG. 2 to identify assets (e.g., manmade features) within the bounding box and categorize assets (e.g., using CIKR categories). This information is provided to the geographic features file generator 224, which provides the GFF 206.

This specification uses the term “configured” in connection with systems and computer program components. For a system of one or more computers to be configured to perform particular operations or actions means that the system has installed thereon software, firmware, hardware, or a combination thereof that, in operation, cause the system to perform the operations or actions. For one or more computer programs to be configured to perform particular operations or actions means that the one or more programs include instructions that, when executed by data processing apparatus, cause the apparatus to perform the operations or actions.

Implementations of the subject matter and the functional operations described in this specification can be realized in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs (i.e., one or more modules of computer program instructions) encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. The program instructions can be encoded on an artificially-generated propagated signal (e.g., a machine-generated electrical, optical, or electromagnetic signal) that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry (e.g., an FPGA (field programmable gate array) or an ASIC (application-specific integrated circuit)). The apparatus can optionally include, in addition to hardware, code that creates an execution environment for computer programs (e.g., code) that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data (e.g., one or more scripts stored in a markup language document) in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in some cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry (e.g., a FPGA, an ASIC), or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data (e.g., magnetic, magneto-optical disks, or optical disks). However, a computer need not have such devices. Moreover, a computer can be embedded in another device (e.g., a mobile telephone, a personal digital assistant (PDA), a mobile audio or video player, a game console, a Global Positioning System (GPS) receiver), or a portable storage device (e.g., a universal serial bus (USB) flash drive) to name just a few.

Computer-readable media suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks.

To provide for interaction with a user, implementations of the subject matter described in this specification can be provisioned on a computer having a display device (e.g., a CRT (cathode ray tube) or LCD (liquid crystal display) monitor) for displaying information to the user and a keyboard and a pointing device (e.g., a mouse, a trackball), by which the user can provide input to the computer. Other kinds of devices can be used to provide for interaction with a user as well; for example, feedback provided to the user can be any form of sensory feedback (e.g., visual feedback, auditory feedback, tactile feedback); and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device (e.g., a smartphone that is running a messaging application), and receiving responsive messages from the user in return.

Data processing apparatus for implementing machine learning models can also include, for example, special-purpose hardware accelerator units for processing common and compute-intensive parts of machine learning training or production (i.e., inference, workloads).

Machine learning models can be implemented and deployed using a machine learning framework (e.g., a TensorFlow framework, a Microsoft Cognitive Toolkit framework, an Apache Singa framework, an Apache MXNet framework).

Implementations of the subject matter described in this specification can be realized in a computing system that includes a back-end component (e.g., as a data server) a middleware component (e.g., an application server), and/or a front-end component (e.g., a client computer having a graphical user interface, a web browser, or an app through which a user can interact with implementations of the subject matter described in this specification, or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a user device (e.g., for purposes of displaying data to and receiving user input from a user interacting with the device), which acts as a client. Data generated at the user device (e.g., a result of the user interaction) can be received at the server from the device.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method for geolocalizing aerial images, the method being executed by one or more processors and comprising:
receiving a first image file recording a first image and a first set of metadata associated with the first image;
determining that the first image depicts a horizon, and in response, providing a modified first set of metadata by:
applying a visibility radius to a projection of the Earth depicted in the first image,
determining a tangent line based on the visibility radius, and
adjusting a height of the first image based on the tangent line to provide a modified height in the modified first set of metadata; and
outputting a first geographic features file that is generated using the modified first set of metadata, the first geographic features file comprising data representing one or more geographic features represented in the first image file.

2. The method of claim 1, further comprising determining an unrolled camera for the first image, the tangent line being determined based on the unrolled camera.

3. The method of claim 2, wherein the unrolled camera is provided by adjusting the first image such that the horizon is parallel to at least one edge of the first image.

4. The method of claim 1, wherein the visibility radius is less than a distance of the horizon from a center of a camera projected to the Earth.

5. The method of claim 1, further comprising determining bounding box data using the first set of modified metadata, wherein the one or more geographic features represented within the first geographic features file are at least partially located within a bounding box defined by the bounding box data.

6. The method of claim 1, further comprising:
receiving a second image file recording a second image and a second set of metadata associated with the second image; and
determining that the second image does not depict a horizon, and in response:
outputting a second geographic features file that is generated using the second set of metadata, the second geographic features file comprising data representing one or more geographic features represented in the second image file.

7. The method of claim 1, wherein determining that the first image depicts a first horizon comprises processing the first image through a machine learning (ML) model that classifies the first image as depicting a horizon.

8. A non-transitory computer storage medium encoded with a computer program, the computer program comprising instructions that when executed by a data processing apparatus cause the data processing apparatus to perform operations for geolocalizing aerial images, the operations comprising:
receiving a first image file recording a first image and a first set of metadata associated with the first image;
determining that the first image depicts a horizon, and in response, providing a modified first set of metadata by:
applying a visibility radius to a projection of the Earth depicted in the first image,
determining a tangent line based on the visibility radius, and
adjusting a height of the first image based on the tangent line to provide a modified height in the modified first set of metadata; and
outputting a first geographic features file that is generated using the modified first set of metadata, the first geographic features file comprising data representing one or more geographic features represented in the first image file.

9. The non-transitory computer storage medium of claim 8, wherein operations further comprise determining an unrolled camera for the first image, the tangent line being determined based on the unrolled camera.

10. The non-transitory computer storage medium of claim 9, wherein the unrolled camera is provided by adjusting the first image such that the horizon is parallel to at least one edge of the first image.

11. The non-transitory computer storage medium of claim 8, wherein the visibility radius is less than a distance of the horizon from a center of a camera projected to the Earth.

12. The non-transitory computer storage medium of claim 8, wherein operations further comprise determining bounding box data using the first set of modified metadata, wherein the one or more geographic features represented within the first geographic features file are at least partially located within a bounding box defined by the bounding box data.

13. The non-transitory computer storage medium of claim 8, wherein operations further comprise:
receiving a second image file recording a second image and a second set of metadata associated with the second image; and
determining that the second image does not depict a horizon, and in response:
outputting a second geographic features file that is generated using the second set of metadata, the second geographic features file comprising data representing one or more geographic features represented in the second image file.

14. The non-transitory computer storage medium of claim 8, wherein determining that the first image depicts a first horizon comprises processing the first image through a machine learning (ML) model that classifies the first image as depicting a horizon.

15. A system, comprising:
one or more processors; and
a computer-readable storage device coupled to the one or more processors and having instructions stored thereon which, when executed by the one or more processors, cause the one or more processors to perform operations for geolocalizing aerial images, the operations comprising:
receiving a first image file recording a first image and a first set of metadata associated with the first image;
determining that the first image depicts a horizon, and in response, providing a modified first set of metadata by:
applying a visibility radius to a projection of the Earth depicted in the first image,
determining a tangent line based on the visibility radius, and
adjusting a height of the first image based on the tangent line to provide a modified height in the modified first set of metadata; and
outputting a first geographic features file that is generated using the modified first set of metadata, the first geographic features file comprising data representing one or more geographic features represented in the first image file.

16. The system of claim 15, wherein operations further comprise determining an unrolled camera for the first image, the tangent line being determined based on the unrolled camera.

17. The system of claim 16, wherein the unrolled camera is provided by adjusting the first image such that the horizon is parallel to at least one edge of the first image.

18. The system of claim 15, wherein the visibility radius is less than a distance of the horizon from a center of a camera projected to the Earth.

19. The system of claim 15, wherein operations further comprise determining bounding box data using the first set of modified metadata, wherein the one or more geographic features represented within the first geographic features file are at least partially located within a bounding box defined by the bounding box data.

20. The system of claim 15, wherein operations further comprise:
receiving a second image file recording a second image and a second set of metadata associated with the second image; and
determining that the second image does not depict a horizon, and in response:
outputting a second geographic features file that is generated using the second set of metadata, the second geographic features file comprising data representing one or more geographic features represented in the second image file.
